(19) United States
(12) Patent Application Publication
(10) Pub. No.: US 2014/0210411 A1
(43) Pub. Date: Jul. 31, 2014

(54) COMPENSATION SYSTEM AND METHOD FOR A BATTERY CHARGER ON BOARD A VEHICLE

(71) Applicants: Frederic Fluxa, Galluis (FR); Christophe Ripoll, Chevreuse (FR)

(72) Inventors: Frederic Fluxa, Galluis (FR); Christophe Ripoll, Chevreuse (FR)

(73) Assignee: RENAULT s.a.s., Boulogne-Billancourt (FR)

(21) Appl. No.: 14/128,401

(22) PCT Filed: Jun. 19, 2012
(86) PCT No.: PCT/FR12/51371

§ 371 Date: Apr. 17, 2014

Related U.S. Application Data
(60) Provisional application No. 61/512,511, filed on Jul. 28, 2011.

(30) Foreign Application Priority Data
Jun. 22, 2011 (FR) 11 55519

(51) Int. Cl. H01F 38/00; B60L 11/18

(52) U.S. Cl. CPC H01F 38/00; B60L 11/1816
USPC 320/109

(57) ABSTRACT

A compensation system for compensating for a leakage current of an electric battery charger on board a vehicle and connected to a power supply network by an electrical ground, by a neutral phase and by at least one phase other than the neutral phase, a residual current differential protection device being interposed between the battery charger and the power supply network, a leakage current flowing from the battery charger to the power supply network on the electrical ground. The compensation system includes a compensation mechanism for compensating for a leakage current and configured to emit, on the electrical ground, a compensation current of same amplitude as the leakage current and of a phase that is the opposite of phase of the leakage current.

The technical field of the invention is battery charging systems and, more particularly, battery chargers on board a motor vehicle.

The use of a non-isolated charger to recharge a battery, notably an electric vehicle battery, may lead to the appearance of a leakage current as it is connected up to the distribution network. This leakage current passes along the electrical ground and may trip the residual current differential protective devices installed between the charger and the distribution network. When these protective devices are tripped, the supply of power to the charger is halted, the process of charging the vehicle therefore being interrupted.

In general, the leakage currents are limited by introducing a transformer with galvanic isolation between the network and the battery. However, the size of these transformers increases with the charging power that passes through them. Battery chargers on board electric motor vehicles are subject to the same unpredictability and the same remedies. However, it is the weight/stored power ratio that defines the range of the vehicle and it is therefore not satisfactory to increase the mass of the vehicle by including transformers with galvanic isolation in the on-board charger.

It is an object of the invention to reduce the leakage currents generated by the charger to a level below the level at which the residual current differential protective devices are tripped, without appreciably increasing the mass of the charger.

Another object of the invention is to provide a leakage current compensation system that can be applied to a charger powered by a single-phase or three-phase distribution network.

One embodiment proposes a compensation system for compensating for a leakage current of an electric battery charger contained within a powertrain on board a vehicle and connected to a power supply network by an electrical ground, by a neutral phase and by at least one phase other than the neutral phase, a residual current differential protection device being interposed between the battery charger and the power supply network. The compensation system comprises a compensation means for compensating for a leakage current flowing from the battery charger to the power supply network on the electrical ground, said compensation means being able to emit, on the electrical ground, a compensation current of the same amplitude as the leakage current and of a phase that is the opposite of the phase of the leakage current.

The invention offers the advantage of passively compensating for a leakage current by generating a compensation current that is superposed on the leakage current, having the same amplitude but the opposite phase. The sum of the currents therefore generates a current of low or zero amplitude.

The leakage current compensation means may comprise one transformer per phase other than the neutral phase of the power supply network, the primary winding of each transformer being connected to one phase of the power supply network, the secondary winding of the transformer being connected to a rectifier bridge, the rectifier bridge being connected to a first end and to a second end of a voltage divider bridge itself associated with capacitors.

The primary windings and the secondary windings of the transformers may be connected to the neutral phase.

The capacitors associated with the voltage divider bridge may comprise a first capacitor connected between the electrical ground and the mid-point of the voltage divider bridge, a second capacitor connected between the mid-point and the second end of the voltage divider bridge, and a third capacitor connected between the electrical ground and the second end of the voltage divider bridge.

The voltage divider bridge may comprise a first end connected to a first resistor in series with a second resistor connected to the second end, the mid-point being situated between the first resistor and the second resistor.

The compensation system may comprise a phase determining means connected between the common mode filter and the powertrain, able to emit on the electrical ground a compensation current of the same amplitude as the leakage current of the common mode filter and of a phase that is the opposite of the phase of the leakage current.

The phase determining means may comprise a first two-position switch and a second two-position switch each of which is connected by its sliding contact to one end of one winding of a transformer, the other winding being connected firstly to the electrical ground via a capacitor and secondly to the sliding contact of a two-position switch, the switches in a first position being connected to the first connection, the switches in a second position being connected to the second connection.

Another aspect of the invention proposes a compensation method for compensating for a leakage current of an electric battery charger contained within a powertrain on board a vehicle and connected to a power supply network by an electrical ground, by a neutral phase and by at least one phase other than the neutral phase, a residual current differential protection device being interposed between the battery charger and the power supply network. There is generated on the electrical ground a compensation current of the same amplitude as a leakage current flowing from the battery charger to the power supply network on the electrical ground and of a phase that is the opposite of the phase of the leakage current.

Part of the power supply voltage can be tapped off, the tapped-off power supply voltage can be phase shifted, and the tapped-off power supply voltage can be converted into a current the amplitude of which is comparable to the amplitude of the leakage current.

The on-board electric battery charger being able to be connected to the power supply network via a common mode filter and a phase determining means connected between the common mode filter and the powertrain, able to emit on the electrical ground a compensation current of the same amplitude as the leakage current of the common mode filter and of a phase that is the opposite of the phase of the leakage current, the phase determining means comprising a first two-position switch and a second two-position switch each of these being connected by their sliding contact to one end of one winding of a transformer, the other winding being connected firstly to the electrical ground via a capacitor and secondly to the sliding contact of a two-position switch, the switches in a first position being connected to the first connection, the switches in a second position being connected to the second connection,

in which, in order to compensate for the leakage current of the common mode filter, if the first connection is carrying the neutral phase, the first switch may be switched to connect the first connection to the first winding of the transformer, the second switch may be switched to connect the second connection to the second winding of the transformer, the third switch may be switched to connect the second winding of the transformer to the first connection.

The on-board electric battery charger being able to be connected to the power supply network via a common mode filter and a phase determining means connected between the common mode filter and the powertrain, able to emit on the electrical ground a compensation current of the same amplitude as the leakage current of the common mode filter and of a phase that is the opposite of the phase of the leakage current, the phase determining means comprising a first two-position switch and a second two-position switch each of these being connected by their sliding contact to one end of one winding of a transformer, the other winding being connected firstly to the electrical ground via a capacitor and secondly to the sliding contact of a two-position switch, the switches in a first position being connected to the first connection, the switches in a second position being connected to the second connection,

in which, in order to compensate for the leakage current of the common mode filter, if the second connection is carrying the neutral phase, the first switch may be switched to connect the second connection to the first winding of the transformer, the second switch may be switched to connect the first connection to the second winding of the transformer, the third switch may be switched to connect the second winding of the transformer to the second connection.

Other objects, features and advantages of the invention will become apparent on reading the following description, given solely by way of nonlimiting example and made with reference to the attached drawings in which:

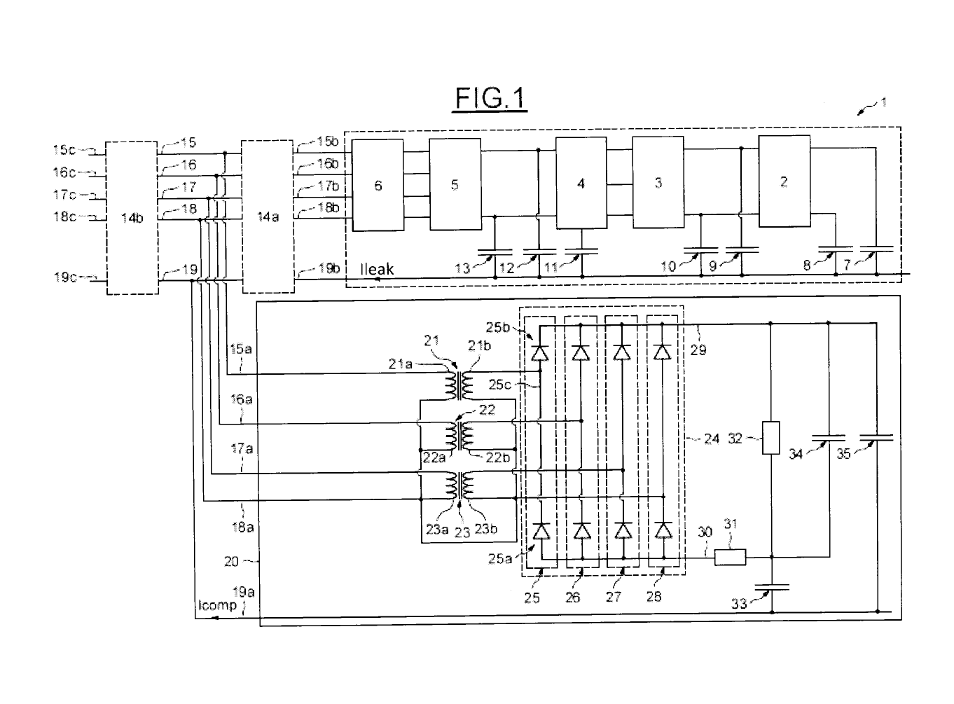

FIG. 1 illustrates a first aspect of a leakage current compensation system according to the invention, and

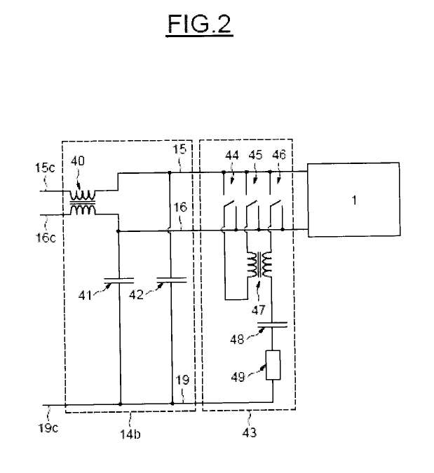

FIG. 2 illustrates a second aspect of a leakage current compensation system according to the invention.

FIG. 1 shows a powertrain 1 comprising, connected in series, a battery 2, a boost device 3, an electric motor 4, a buck device 5 and a capacitors device 6.

A boost device 3 is a device that makes it possible to generate an output DC voltage that is higher than the input DC voltage.

The buck device 5 is a series chopper that allows the output voltage to be reduced very efficiently.

The powertrain 1 is connected at output to a differential mode filter 14a by as many connections as there are power supply phases 15b to 18b and by an electrical ground connection 19b. The differential mode filter 14a is connected to a common mode filter 14b in the same way by electrical connections 15 to 19.

The common mode filter 14b is itself connected to the electrical power supply network by power supply phase connections 15c to 18c and by an electrical ground connection 19c.

Operation of the powertrain 1 generates a common mode voltage that leads to a leakage current into the electrical ground.

Coupling therefore appears between the elements of the powertrain 1 and the electrical ground. Capacitors, referenced 7 to 13, symbolize the coupling derived from the common mode voltages between the electrical ground and, respectively, the battery 2, the boost device 3, the electric motor 4, the buck device 5 and the capacitors device 6.

The couplings described hereinabove result either from parasitic phenomena or from normal operation of the components. It is therefore not possible to tackle the root cause of the leakage current in order to prevent it from being created.

The leakage current compensation system comprises a compensation means 20 connected between the common mode filter 14b and the differential mode filter 14a by electrical connections 15a to 18a connected to the various power supply phases and by an electrical connection 19a connected to the electrical ground. The connections 15a to 19a are essentially tappings off the connections 15 to 19.

The leakage current compensation means 20 comprises one connection per power supply phase other than the neutral phase 15a, 16a, 17a, one connection 18a for the neutral phase and one connection 19a for the electrical ground. The connections 15a to 17a for power supply phases other than the neutral phase are each connected to one terminal of the primary winding 21a to 23a of a transformer 21 to 23. The other terminals of the primary windings 21a to 23a are together connected to the neutral phase connection 18a. The terminals of each of the secondary windings 21b to 23b are together connected to the neutral phase connection 18a. The other terminals of each of the secondary windings 21b to 23b are connected to one of the legs 25 to 28 of a diode rectifier bridge 24.

A first leg 25 of a diode rectifier bridge comprises a first diode 25a connected by its cathode to the anode of a second diode 25b. The output voltage of the leg is obtained between the connection upstream of the first diode 25a and the connection downstream of the second diode 25b.

The input voltage of the first leg 25 is applied between the electrical ground connector 19a and the connector 25c situated between the first diode 25a and the second diode 25b. The other legs 26 to 28 have the same structure as the first leg 25. The four legs illustrated in FIG. 1 are connected together in parallel.

The output connections 29 and 30 of the diode rectifier bridge 24 are connected to the outputs of the four legs.

The compensation system comprises a voltage divider bridge comprising a first end connected to a first resistor 31 in series with a second resistor 32 connected to a second end, a mid-point being situated between the first resistor 31 and the second resistor 32.

A voltage divider bridge is connected via the first end to the output connection 30 of the diode rectifier bridge 24 and via the second end to the connection 29.

The compensation system also comprises capacitors connected at the output of the voltage divider bridge.

A first capacitor 33 is connected between the electrical ground connector 19a and the mid-point of the voltage divider bridge.

A second capacitor 34 is connected between the mid-point and the second end of the voltage divider bridge.

A third capacitor 35 is connected between the electrical ground and the second end of the voltage divider bridge.

The transformers 21 to 23 then allow the signal emitted by their secondary windings to be phase shifted in relation to the signal received on the primary windings. More specifically, the signal emitted by the secondary windings is in phase opposition to the signal received on the primary windings. The phase can be inverted because the primary and secondary windings are together connected to the neutral phase. Moreover, the secondaries of the transformers are connected in such a way that the output voltage is in phase opposition to the input voltage. Connecting the primary and secondary neutrals to the electrical ground, through the capacitor 39, allows the compensation current to flow to the connection 19.

The diode rectifier bridge 24 coupled to the voltage divider bridge and to the capacitors 33 to 35 makes it possible to reproduce a current that has the same amplitude as, but is in phase opposition to, the leakage current. The compensation current is emitted by the electrical ground connector 19a toward the common mode filter 14b. The compensation current flows in the same direction as the leakage current with the same amplitude but in phase opposition, so the resultant current has a low or zero amplitude.

It is also clear that although described in the context of a three-phase power supply, the embodiments described hereinabove can be transferred to a single-phase power supply in which just three power supply conductors are needed rather than five. The compensation system then becomes simpler requiring only one transformer and a two-leg diode rectifier bridge and two compensation capacitors.

FIG. 2 illustrates another aspect of the compensation system in which leakage currents that appear because of the presence of the common mode filter 14b are compensated. In addition, this other aspect shows how the compensation system is applied to a two-phase installation in which the position of the neutral is unknown.

FIG. 2 shows the common mode filter 14b connected at input to the electrical ground connection 19c and to two phase connections 15c and 16c. The connection 15c is connected to a first winding of a transformer 40, the first winding moreover being connected to the first connection 15. The connection 15c is connected to a second winding of the transformer 40, the second winding being connected to the second connection 16. A capacitor 41 is connected between the first winding of the transformer 40 and the electrical ground connection 19c. Likewise, a capacitor 42 is connected between the first winding of the transformer 40 and the electrical ground connection 19c.

The connection 19c is moreover connected at the output of the common mode filter 14b to the connection 19.

A phase determining means 43 connected at input to the common mode filter 14b and at output to the powertrain 1 and comprising three two-position switches (44,45,46), a two-winding transformer 47, a capacitor 48 and a resistor 49 may also be seen.

The first two-position switch 44 is connected via one position to the first connection 15, via the other position to the second connection 16, and via the switch to a first terminal of a first winding of the transformer 47.

The second two-position switch 45 is connected by one position to the first connection 15, by the other position to the second connection 16, and by the switch to the second terminal of the first winding of the transformer 47.

The third two-position switch 46 is connected by one position to the first connection 15, by the other position to the second connection 16, and by the switch to a first terminal of the second winding of the transformer 47. The second terminal of the second winding of the transformer 47 is connected to the capacitor 48, itself connected at output to the resistor 49. The resistor 49 is connected to the connection 19.

In a domestic installation, the neutral phase may indiscriminately be on one or other of the phases of a two-phase installation. The phase determining means 43 allows the leakage current compensation to be adapted according to whether it is the first connection 15 or the second connection 16 that is carrying the neutral phase. If the neutral is on the connector 15, a compensation current is injected via the capacitor 42. If the neutral is on the connector 16, a compensation current is injected via the capacitor 41.

To achieve that, if the neutral is on the first connection 15, the first switch 44 connects the first connection 15 to the first winding of the transformer 47, while the second switch 45 connects the second connection 16 to the second winding of the transformer 47. The third switch 46 connects the second winding of the transformer 47 to the first connection 15.

If the neutral is on the second connection 16, the first switch 44 connects the second connection 16 to the first winding of the transformer 47, while the second switch 45 connects the first connection 15 to the second winding of the transformer 47. The third switch 46 connects the second winding of the transformer 47 to the second connection 16.

A method for compensating a leakage current entails generating on the electrical ground a compensation current of the same amplitude as a leakage current flowing from the battery charger to the power supply network on the electrical ground, and of a phase that is the opposite of the phase of the leakage current.

To do that, part of the power supply voltage may be tapped off, phase shifted and converted into a current the amplitude of which is comparable with the amplitude of the leakage current.

The compensation system is a passive system the components of which are determined according to the common mode couplings of the circuit to be compensated. If the strength of the leakage current is higher than the strength on the basis of which the device has been designed and rated, it is possible to compensate for the excess leakage current using an active system.

Such an active system may comprise a leakage current detection circuit intended to be connected to connections to the electrical power supply network, an electrical ground current measurement circuit, and means for controlling the operation of the device according to the estimated level of leakage currents and the measured level of the electrical ground current. The active system allows or prevents the application of electrical power to the charger according to the strength of the leakage and electrical ground currents, particularly if the leakage current is not compensated by the electrical ground current.

The compensation system described hereinabove thus makes it possible to reduce or even eliminate the leakage current that may result from common mode coupling of the elements of a powertrain with a battery charger on board a vehicle.

1-10. (canceled)

11. A compensation system for compensating for a leakage current of an electric battery charger within a powertrain on board a vehicle and connected to a power supply network by an electrical ground, by a neutral phase and by at least one phase other than the neutral phase, a residual current differential protection device being interposed between the battery charger and the power supply network, the system comprising:
a compensation means for compensating for a leakage current flowing from the battery charger to the power supply network on the electrical ground, the compensation means configured to emit, on the electrical ground, a compensation current of same amplitude as the leakage current and of a phase that is the opposite of phase of the leakage current.

12. The compensation system as claimed in claim 11, in which the leakage current compensation means comprises one transformer per phase other than the neutral phase of the power supply network, a primary winding of each transformer being connected to one phase of the power supply network, a secondary winding of the transformer being connected to a rectifier bridge,
the rectifier bridge being connected to a first end and to a second end of a voltage divider bridge itself associated with capacitors.

13. The compensation system as claimed in claim 12, in which the primary windings and the secondary windings of the transformers are connected to the neutral phase.

14. The compensation system as claimed in claim 12, in which the capacitors associated with the voltage divider bridge comprise:
a first capacitor connected between the electrical ground and a mid-point of the voltage divider bridge,
a second capacitor connected between the mid-point and a second end of the voltage divider bridge, and
a third capacitor connected between the electrical ground and the second end of the voltage divider bridge,
the voltage divider bridge comprising a first end connected to a first resistor in series with a second resistor connected to the second end, the mid-point being situated between the first resistor and the second resistor.

15. The compensation system as claimed in claim 11, further comprising a phase determining means connected between a common mode filter and the powertrain, configured to emit on the electrical ground a compensation current of same amplitude as the leakage current of the common mode filter and of a phase that is the opposite of phase of the leakage current.

16. The compensation system as claimed in claim 15, in which the phase determining means comprises a first two-position switch and a second two-position switch each of which is connected by its sliding contact to one end of one winding of a transformer, the other winding being connected to the electrical ground via a capacitor and to the sliding contact of a two-position switch, the switches in a first position being connected to the first connection, the switches in a second position being connected to the second connection.

17. A compensation method for compensating for a leakage current of an electric battery charger contained within a powertrain on board a vehicle and connected to a power supply network by an electrical ground, by a neutral phase and by at least one phase other than the neutral phase, a residual current differential protection device being interposed between the battery charger and the power supply network, the method comprising:
generating on the electrical ground a compensation current of same amplitude as a leakage current flowing from the battery charger to the power supply network on the electrical ground and of a phase that is the opposite of phase of the leakage current.

18. The method as claimed in claim 17, in which
part of the power supply voltage is tapped off,
the tapped-off power supply voltage is phase shifted,
the tapped-off power supply voltage is converted into a current the amplitude of which is comparable to the amplitude of the leakage current.

19. The method as claimed in claim 17, the on-board electric battery charger being connected to the power supply network via a common mode filter and a phase determining means connected between a common mode filter and the powertrain, configured to emit on the electrical ground a compensation current of same amplitude as the leakage current of the common mode filter and of a phase that is the opposite of phase of the leakage current,
the phase determining means comprising a first two-position switch and a second two-position switch each of these being connected by their sliding contact to one end of one winding of a transformer, the other winding being connected to the electrical ground via a capacitor and to the sliding contact of a two-position switch, the switches in a first position being connected to the first connection, the switches in a second position being connected to the second connection,
in which, to compensate for the leakage current of the common mode filter, if the first connection is carrying the neutral phase, the first switch is switched to connect the first connection to the first winding of the transformer, the second switch is switched to connect the second connection to the second winding of the transformer, the third switch is switched to connect the second winding of the transformer to the first connection.

20. The method as claimed in claim 17, the on-board electric battery charger being connected to the power supply network via a common mode filter and a phase determining means connected between a common mode filter and the powertrain, configured to emit on the electrical ground a compensation current of same amplitude as the leakage current of the common mode filter and of a phase that is the opposite of phase of the leakage current,
the phase determining means comprises a first two-position switch and a second two-position switch each of these being connected by their sliding contact to one end of one winding of a transformer, the other winding being connected to the electrical ground via a capacitor and to the sliding contact of a two-position switch, the switches in a first position being connected to the first connection, the switches in a second position being connected to the second connection,
in which, to compensate for the leakage current of the common mode filter, if the second connection is carrying the neutral phase, the first switch is switched to connect the second connection to the first winding of the transformer, the second switch is switched to connect the first connection to the second winding of the transformer, the third switch is switched to connect the second winding of the transformer to the second connection.
